(19) United States
(12) Patent Application Publication
(10) Pub. No.: US 2013/0232002 A1
(43) Pub. Date: Sep. 5, 2013

(54) System and Method for Managing Requests for Service

(71) Applicants: Yong Zhao, Ma Wan (HK); Yi Zhao, Gaithersburg, MD (US); McEvan Baum, Ranson, WV (US)

(72) Inventors: Yong Zhao, Ma Wan (HK); Yi Zhao, Gaithersburg, MD (US); McEvan Baum, Ranson, WV (US)

(21) Appl. No.: 13/780,227

(22) Filed: Feb. 28, 2013

Related U.S. Application Data
(60) Provisional application No. 61/606,014, filed on Mar. 2, 2012.

(51) Int. Cl. G06Q 30/06

(52) U.S. Cl. CPC G06Q 30/0613
USPC 705/14.49; 705/26.41; 705/26.4

(57) ABSTRACT

A present invention embodiment provides a system for connecting service seekers with service providers in order for the service providers to perform a desired service. The system handles service requests and comprises a computer system including at least one processor. The system receives one or more service requests from service seekers requesting performance of a service. Service providers that provide the requested services are identified based on at least the current location of the service providers relative to the location for performing the requested service. The system further facilitates communication between the service seekers and the identified service providers. Embodiments of the present invention further include a method and computer program product for handling service requests in substantially the same manner described above.

### CROSS-REFERENCE TO RELATED APPLICATIONS

This application claims priority from U.S. Provisional Patent Application Ser. No. 61/606,014, entitled “Real-Time Platform For Connecting Service Seekers and Service Providers” and filed Mar. 2, 2012, the disclosure of which is incorporated herein by reference in its entirety.

### BACKGROUND

1. Technical Field

Present invention embodiments relate to managing requests for service, and more specifically, to identifying one or more service providers capable of handling a service request and notifying an originator of the service request of the identified service providers.

2. Discussion of the Related Art

Currently, there are a limited amount of ways for service seekers (e.g., persons or entities searching for a service provider to perform a service) to connect with service providers. One way is for service seekers to provide information pertaining to a desired service and have that information dispatched randomly to a set number of service providers. Another way is for service seekers to browse a directory of service providers, pick the ones they are interested in contacting, call them, and out of the ones that actually answer or return the call, try to schedule an appointment for an estimate. No consideration is given to the service provider's current location or level of interest.

### SUMMARY

A present invention embodiment provides a real-time system for connecting service seekers with service providers in order for the service providers to perform a desired service. The system handles service requests and comprises a computer system including at least one processor. The system receives one or more service requests from service seekers requesting performance of a service. Service providers that provide the requested services are identified based on at least the current location of the service providers relative to the location for performing the requested service. The system further facilitates communication between the service seekers and the identified service providers. Embodiments of the present invention further include a method and computer program product for handling service requests in substantially the same manner described above. The present invention embodiments make the process of connecting service seekers with service providers faster and more efficient, thereby saving time and money for both parties.

The above and still further features and advantages of the present invention embodiments will become apparent upon consideration of the following detailed description of example embodiments thereof, particularly when taken in conjunction with the accompanying drawings wherein like reference numerals in the various figures are utilized to designate like components.

### BRIEF DESCRIPTION OF THE DRAWINGS

FIG. 1 depicts an example service request form on a web browser according to an embodiment of the present invention.

FIG. 2 depicts an example service request form on a mobile application according to an embodiment of the present invention.

FIG. 3 depicts an example estimate notification window according to an embodiment of the present invention.

FIG. 4 depicts an example implementation of a map of service providers according to an embodiment of the present invention.

FIG. 5 depicts an example directory of service providers according to an embodiment of the present invention.

FIG. 6 depicts an example service request details page on a web browser according to an embodiment of the present invention.

FIG. 7 depicts an example chat screen for a web browser enabling a chat session between a service seeker and service provider according to an embodiment of the present invention.

FIG. 8 depicts an example service request details screen on a mobile application according to an embodiment of the present invention.

FIG. 9 depicts an example chat screen for a mobile application enabling a chat session between a service seeker and service provider according to an embodiment of the present invention.

FIG. 10 depicts an example of a location and behavior sensitive coupon according to an embodiment of the present invention.

FIG. 11 depicts an example sequence of screens (e.g., showing the process of a service provider receiving a new service request notification, viewing and accepting the details of the service request, viewing the service seeker's contact information and giving an instant estimate back to the service seeker) according to an embodiment of the present invention.

FIG. 12 depicts an example map of service seekers according to an embodiment of the present invention.

FIG. 13 depicts an example directory of service requests according to an embodiment of the present invention.

FIG. 14 depicts an example promotion screen for creating a promotion (e.g., advertisement, deal, or coupon) according to an embodiment of the present invention.

FIG. 15 is a flow diagram illustrating a manner of distributing service requests to service providers according to an embodiment of the present invention.

FIG. 16 depicts an example system architecture of an embodiment of the present invention.

### DETAILED DESCRIPTION OF EXAMPLE EMBODIMENTS

Present invention embodiments pertain to a real-time system where service seekers can look for services, submit multimedia service requirements to service providers, receive instant quotes from the service providers for services needed, and engage in a real-time chat with service providers to ask follow-up questions. The system further enables service providers to browse, receive/answer leads, and submit instant estimates to and chat in real-time with service seekers. In addition, advertisers can target specific types of users in a specific location, based on user behavior, with location-sensitive and behavior-sensitive advertisements, deals, and/or coupons.

A service seeker includes any individual or entity that is in need of or searching for a particular service. Some examples of service seekers include a home owner seeking a plumber to unclog a toilet, a hotel looking for a tree service company to remove a fallen tree caused by a recent storm from its premises, etc.

A service provider includes any individual or entity that provides a service. Some examples of service providers include an animal control specialist who removes unwanted animals, HVAC specialist who repairs air conditioners, etc.

An advertiser includes any individual or entity that would like to advertise on the system (e.g., service providers, product providers, advertising agencies, etc.). Some examples of advertisers include a hardware store selling tools, an acupuncturist advertising massage services, a restaurant promoting a lunch special, etc.

Present invention embodiments connect the service seekers and service providers, and perform other business tasks as described below.

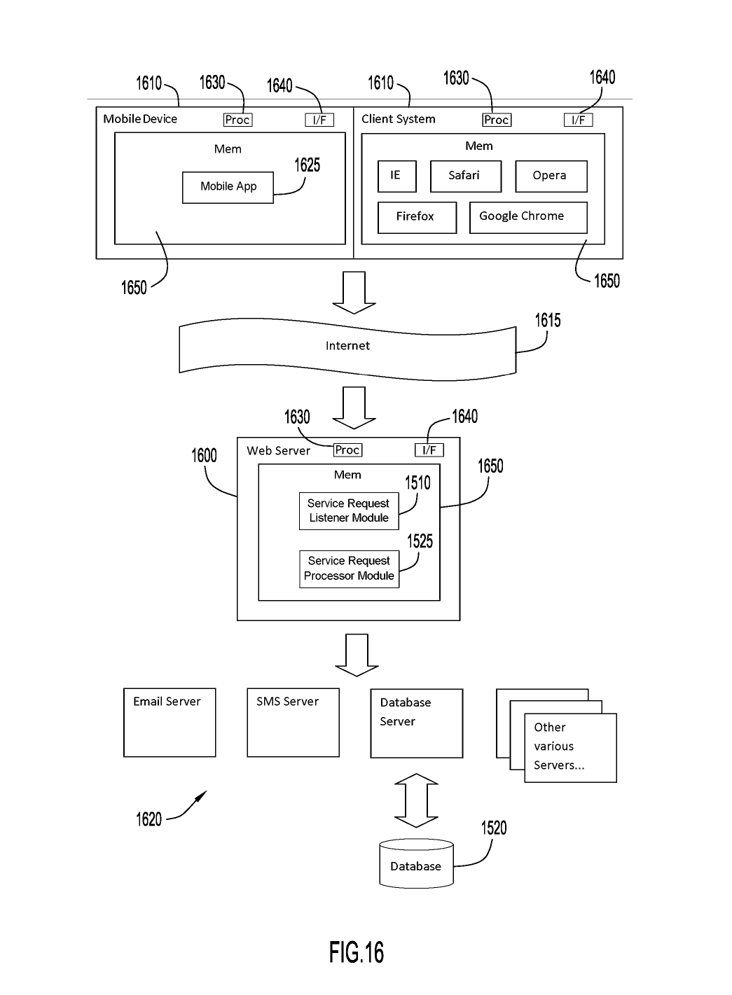

The system of a present invention embodiment provides a myriad of services for service seekers. A first service the system offers is a way for service seekers to broadcast the type of service which they are seeking (e.g., making a service request), using multimedia, to a server system (e.g., described below for FIG. 16). The server system dispatches these service requests to the appropriate service providers, thereby allowing the service providers to respond to the service seekers with an estimate and allowing the service seekers and service providers to chat further about the service request in real-time as described below. The first service can be accessed in plural manners. A first manner is a website of the server system (FIG. 16) accessed from a web browser of a client system. From a web browser, the service seeker goes through a series of steps to provide all the necessary information about the work the service seeker desires to be performed, which includes a service location, photographs, recorded video, recorded voice, and a text description.

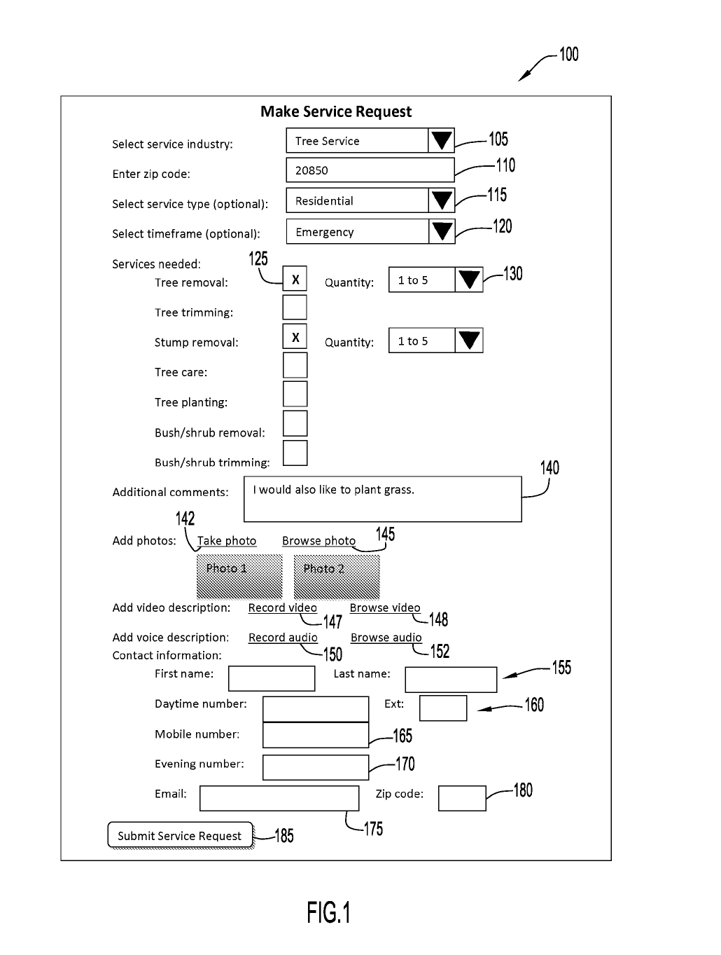

An example service request form 100 is depicted in FIG. 1. Initially, the service seeker fills out the form to provide information about the service that the service seeker needs performed (or is the subject of a search) and submits the service request. Form 100 may be presented from a main option or other screen. In this figure, the service seeker initially selects the service industry (e.g., tree service) in field 105. The rest of the page or form appears, corresponding to the industry that was selected, and the service seeker fills out the industry specific form portions as follows:

enters the service zip code in a field 110;

optionally selects service or project type (e.g., residential, commercial, government, etc.) in a field 115;

optionally selects a timeframe (e.g., emergency, within a couple of days, within a week, within a month, flexible, etc.) in a field 120;

optionally indicates if tree removal is needed in a corresponding selection field 125 and, if so, enters a quantity in a corresponding quantity field 130;

optionally indicates if tree trimming is needed in a corresponding selection field 125 and, if so, enters a quantity in a corresponding quantity field 130;

optionally indicates if stump removal is needed in a corresponding selection field 125 and, if so, enters a quantity in a corresponding quantity field 130;

optionally indicates if tree care is needed in a corresponding selection field 125 and, if so, enters a quantity in a corresponding quantity field 130;

optionally indicates if tree planting is needed in a corresponding selection field 125 and, if so, enters a quantity in a corresponding quantity field 130;

optionally indicates if bush/shrub removal is needed in a corresponding selection field 125 and, if so, enters a quantity in a corresponding quantity field 130;

optionally indicates if bush/shrub trimming is needed in a corresponding selection field 125 and, if so, enters a quantity in a corresponding quantity field 130;

optionally enters additional comments into a text area 140;

optionally takes photographs via actuator or link 142 (e.g., opens a web camera on the computer) or browses for photographs via actuator or link 145 (e.g., opens a popup window allowing selection of photographs from the computer) describing the service;

optionally records a video file via actuator or link 147 (e.g., opens a web camera on the computer) or browses for video via actuator or link 149 (e.g., opens a popup window allowing selection of a video file from the computer) describing the service;

optionally records an audio file via an actuator or link 150 (e.g., opens computer's microphone) or browses for an audio file via an actuator or link 152 (e.g., opens a popup window allowing selection of an audio file from the computer) describing the service;

optionally enters contact information (e.g., however if a service seeker has an account and is logged-in, the contact information is auto filled and the service request is saved in the service seeker's activity history for tracking) including a name in name fields 155 (e.g., including a first name and a last name), a daytime telephone number with optional extension in telephone number fields 160, a mobile telephone number in field 165, an evening telephone number in a field 170, an e-mail address in a field 175, and a zip code in a field 180; and

submits the service request via link or actuator 185.

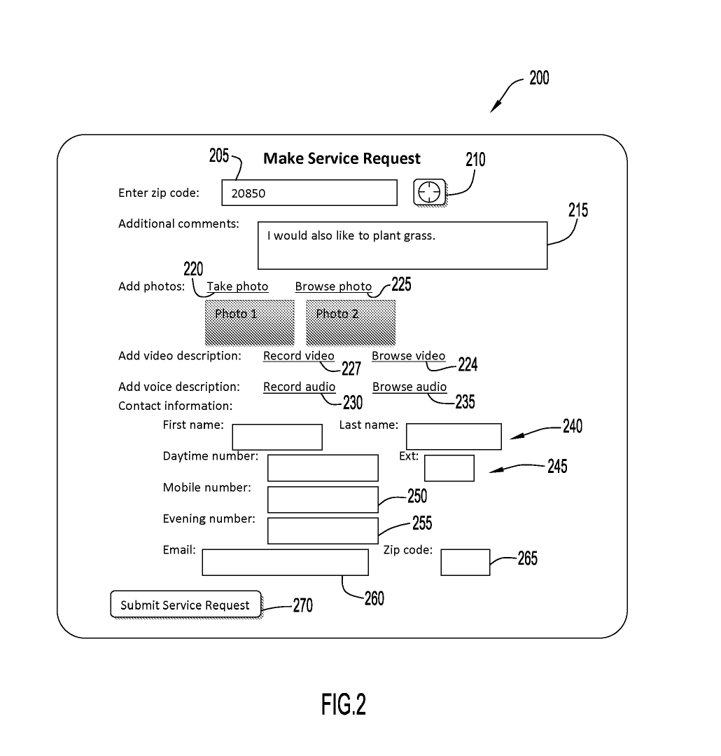

A second manner of accessing the service includes a mobile application (FIG. 16) that runs on a mobile telephone. From the mobile application, the service seeker goes through a series of steps to provide all the necessary information about the work the service seeker desires to be performed, which includes service location, photographs, recorded video, recorded voice, text description, etc. An example service request form 200 is depicted in FIG. 2. Initially, the service seeker fills out the form to provide information about the service that the service seeker needs performed (or is the subject of a search) and submits the service request. Form 200 may be presented from a main option or other screen. The service seeker initially selects the service industry (e.g., tree service), and the rest of the page appears, corresponding to the industry that was selected, and an industry specific form is completed by the service seeker as follows:

enters the service zip code in a field 205 or presses a location service button 210 to retrieve a current zip code;

optionally enters comments into a text area 215;

optionally takes photographs via an actuator or link 220 (e.g., opens a camera on the mobile telephone) or browses for photographs via an actuator or link 225 (e.g., opens a new screen allowing selection of photographs from the mobile telephone's library) describing the service;

optionally records a video file (e.g., opens a video camera on the mobile telephone) via an actuator or link 227 or browses for a video file via an actuator or link 224 (e.g., opens a new screen allowing selection of a video file from the mobile telephone's library) describing the service;

optionally records an audio file via an actuator or link 230 (e.g., opens a voice recorder on the microphone) or browses for an audio file via an actuator or link 235 (e.g., opens a new screen allowing selection of an audio file from the mobile telephone's library) describing the service;

optionally enters contact information (e.g., however, if the service seeker has an account and is logged-in, the contact information is auto filled and the service request is saved in the service seeker's activity history for tracking) including a name in fields 240 (e.g., first name and last name), a daytime telephone number with optional extension in fields 245, a mobile telephone number in a field 250, an evening telephone number in a field 255, an e-mail address in a field 260, and a zip code in a field 265; and

submits the service request via an actuator or link 270.

After the service request is submitted to the server system (FIG. 16) and dispatched to the appropriate service providers, the service providers that receive the submission can choose to manually contact the service seeker, submit an estimate, which includes cost and optional additional comments, or engage in a real-time chat with the service seeker to ask follow-up questions as described below. There are plural ways for the service seeker to receive estimates, including web notification, mobile application notification, e-mail, and SMS (text messages). Service seekers can choose to receive web notifications, which allow them to receive popup notifications regarding the estimates on the website. Service seekers can also choose to receive mobile application notifications, which allow them to receive popup notifications regarding the estimates on their mobile applications.

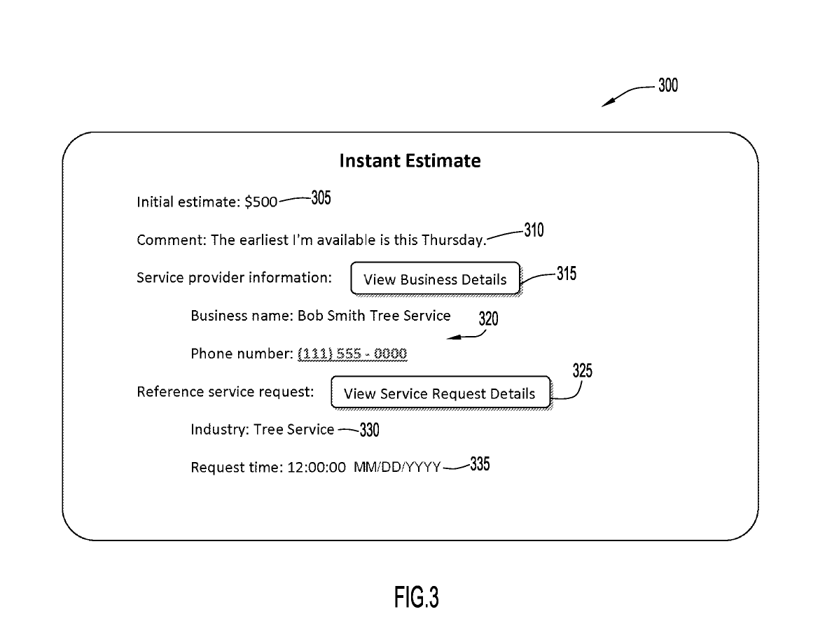

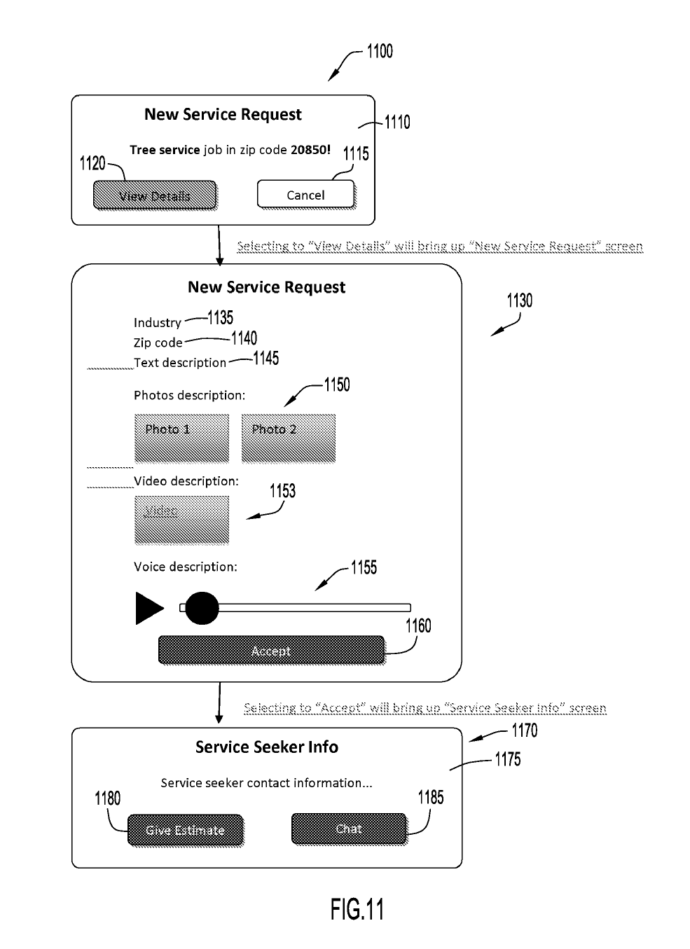

An example estimate notification window 300 is depicted in FIG. 3. Initially, the service provider can send the service seeker estimates (preferably instantly) in response to the service seeker's service request (e.g., FIG. 11). The estimate notification window indicates an estimate 305, an optional comment 310, service provider or business information 320 (e.g., name, telephone number, etc.), an industry type 330, and a timestamp 335 (e.g., date, time, etc.) for the service request. The estimate notification window further includes an actuator or link 315 to provide further information about the service provider or business, and a link or actuator 325 to provide information about the service request.

Service seekers can choose to receive e-mails or SMS (text messages) regarding estimates. There are also plural ways for service seekers to engage in a real-time chat with service providers to ask follow-up questions, including web chat and mobile application chat, which allows them to ask follow-up questions using text, photographs, video, audio, etc. The service provider can reply via the web or mobile application using text, photographs, video, audio, etc. This service further allows service seekers to view their service request history via the web and mobile application.

A second service for service seekers includes a way to browse for service providers. The service seekers can browse a list of service providers in the form of a directory or a map. The service seeker can further drill down into a service provider's business profile to view detailed information, and to make a service request.

The second service can be accessed in plural manners. A first manner for browsing service providers is a website of a server system (FIG. 16) accessed from a web browser of a client system. From a web browser, the service seeker can choose to either browse a directory or a map of service providers near the service location. If the service seeker chooses to browse a directory, a list of service providers can be viewed and sorted by the following criteria: alphabetical order; and distance from a service location to where the service provider is located (e.g., a static location or a current location), where both the service seeker and service provider can access this service via a location-aware device (e.g., a smart phone, etc.) which can keep track of their location in order to sort by current location.

If the service seeker chooses to browse a map, the service seeker can view a map of all service providers and can filter results by the following criteria: service provider's business location; and current location of the service provider.

A second manner of browsing service providers includes a mobile application (FIG. 16) accessed from a mobile telephone. From a mobile telephone, the service seeker can choose to browse a directory or a map of service providers near the service location. If the service seeker chooses to browse a directory, the service seeker can view a list of service providers, and can sort by the following criteria: alphabetical order; and distance from a service location to where the service provider is located (e.g., a static location or a current location). The service seeker and service provider can access this service via a location-aware device (e.g., a smart phone, etc.) which can keep track of their location in order to sort by current location.

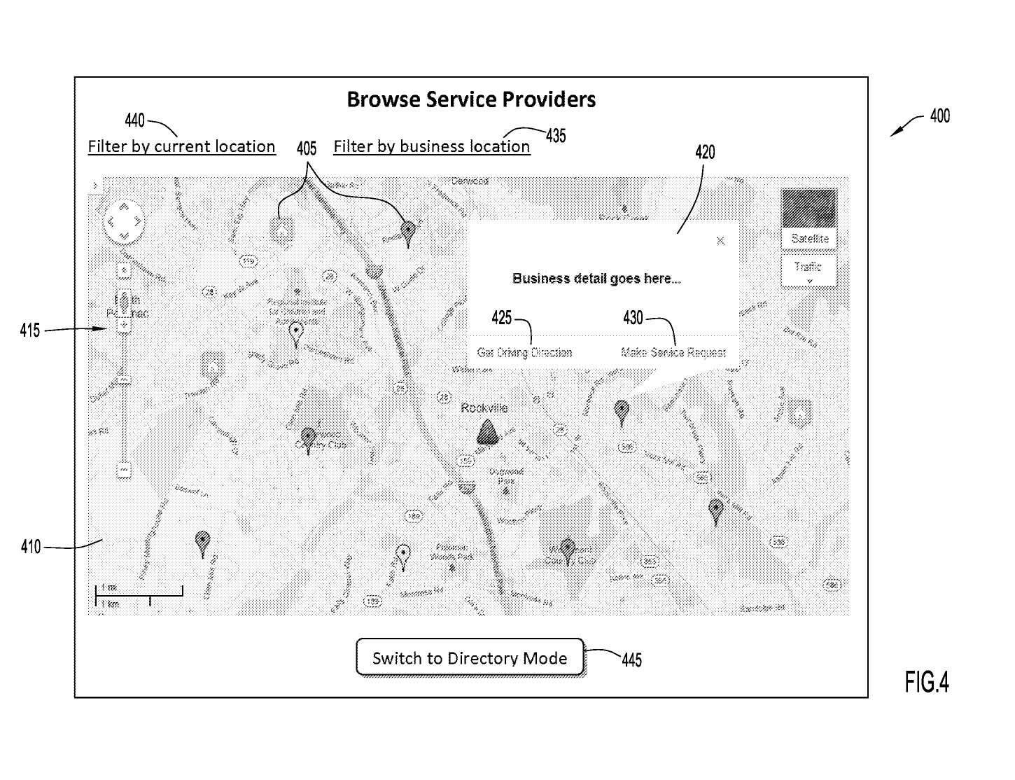

An example map of service providers 400 (e.g., from a web browser or mobile application) is depicted in FIG. 4. Initially, map 400 may be presented from a main option or other screen. The service seeker can view a map of all service providers, and click on associated icons 405 for detailed information about a corresponding service provider. In particular, the service seeker enters the service zip code (not shown in FIG. 4), and a map 410 appears centered at the service zip code, having a default radius of a predetermined number of miles. The zoom level of the map can be adjusted from the top left by clicking on + or − buttons 415.

Icons 405 on the map represent service providers, where generally rectangular icons 405 including buildings represent the service providers' respective business locations, while generally circular icons represent the service providers' respective current locations. The icons representing current locations are color coded according to the time at which the service provider's reported location was reported (e.g., green indicates that the location was reported within a predetermined number of minutes, yellow indicates that the location was reported between a predetermined number of minutes and a predetermined number of hours ago, and red indicates that the location was reported in a range of a predetermined number of hours ago). By clicking on an icon of a specific service provider, service seekers can view that service provider's detailed profile information 420, get driving directions via actuator or link 425, and make a service request to that provider via actuator or link 430.

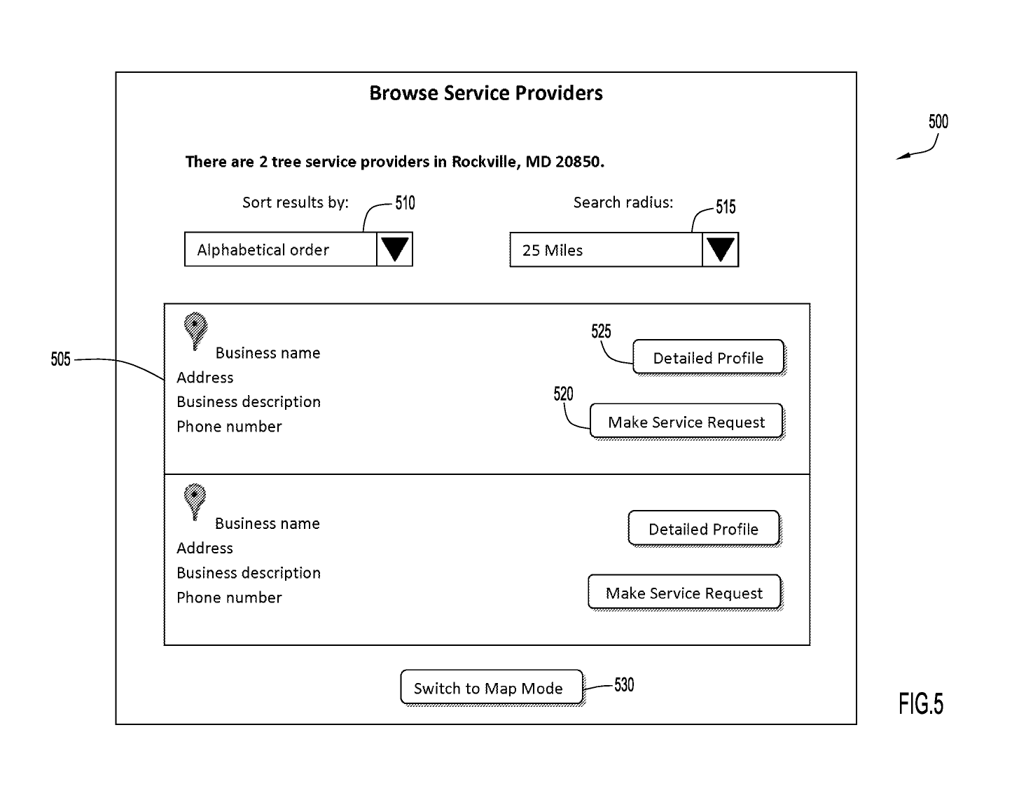

In addition, service seekers can also filter the map to see service provider business locations via an actuator or link 435, current locations via an actuator or link 440, or both. Further, there is a button 445 on this page to allow the service seekers to switch to a directory mode (e.g., substantially similar to FIG. 5 described below).

An example directory of service providers 500 (e.g., from a web browser or a mobile application) is depicted in FIG. 5. Initially, directory 500 may be presented from a main option or other screen (e.g., FIG. 4). The service seeker can view a list of service providers 505, and click on each for detailed information about that service provider. The service seeker enters the service zip code (not shown in FIG. 5), and a directory appears with a list of service providers 505, having a default search radius of a number miles. At the top of the list, there is an actuator or drop-down list 510 that allows service seekers to sort by alphabetical order or distance. There is another actuator or drop-down list 515 that allows service seekers to change the search radius. A subset of each service provider's profile information is shown in list 505 (e.g., industry, brief description of the business, address, user ratings, distance to service location, a current location icon if this is the current location of the service provider, etc.). In addition, each service provider is associated with a make service request button 520 to initiate a service request. Clicking on a detailed profile button 525 of a service provider brings up a new page with the detailed profile information, and also gives the service seeker the ability to make a service request to the selected service provider. There is a further button 530 on this page that allows service seekers to switch to map mode (e.g., substantially similar to FIG. 4 described above). For example, if the service seeker chooses to browse a map, the service seeker can view a map of all service providers and can filter the results shown on the map by the following criteria: service provider's business location and current location of service provider.

A third service provided by the system is a way for service seekers to engage in a real-time, multimedia chat with the service provider. Service seekers can use multimedia (e.g., text, photographs, video, audio, etc.) to ask follow-up questions and chat with service providers. Service providers can reply with multimedia (e.g., text, photographs, video, audio, etc.).

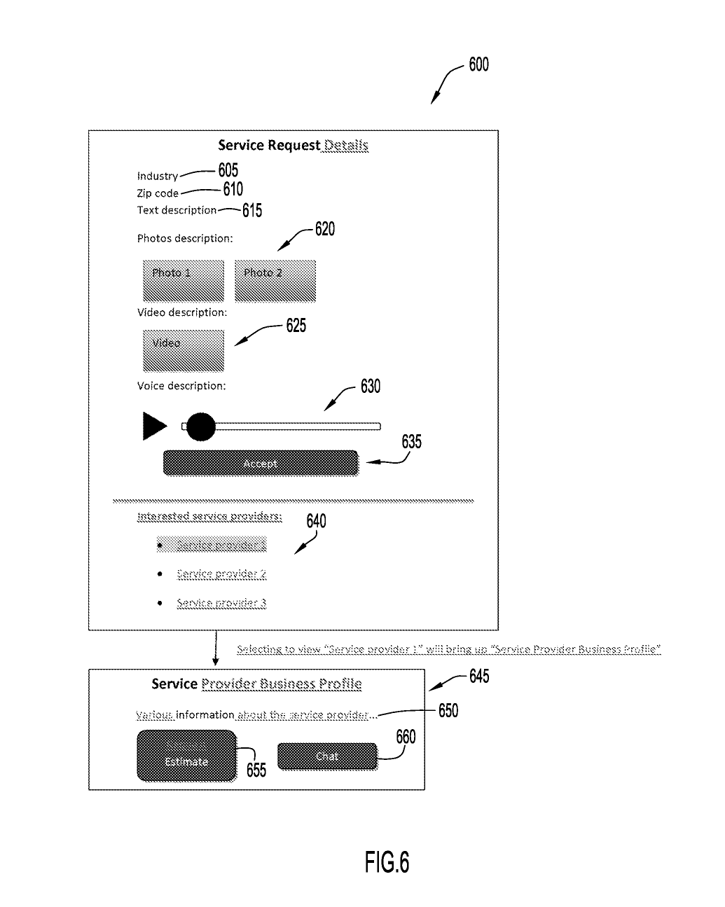

The third service can be accessed in plural manners. A first manner includes a website of a server system (FIG. 16) accessed from a web browser of a client system. From the web browser, there will be a page 600 that displays the details of a service request as illustrated, by way of example, in FIG. 6. Page 600 may be presented from a main option or other screen (e.g., FIG. 3). Within this page, there is information about the service request, including industry 605, zip code 610, a text description 615, photographs 620, video 625, and a voice description 630. An accept button 635 enables the service seeker to accept an offer from a service provider. In addition, page 600 includes a service provider section 640 that lists service providers who show interest in the service request. Clicking on a service provider shows a business profile screen 645 for the selected service provider including various information 650, an estimate button 655 and a chat button 660. The estimate button requests an estimate from the selected service provider, while the chat button initiates a real-time chat. After entering into a chat, a popup window appears, allowing service seekers to engage in a multimedia chat with the service provider as described below.

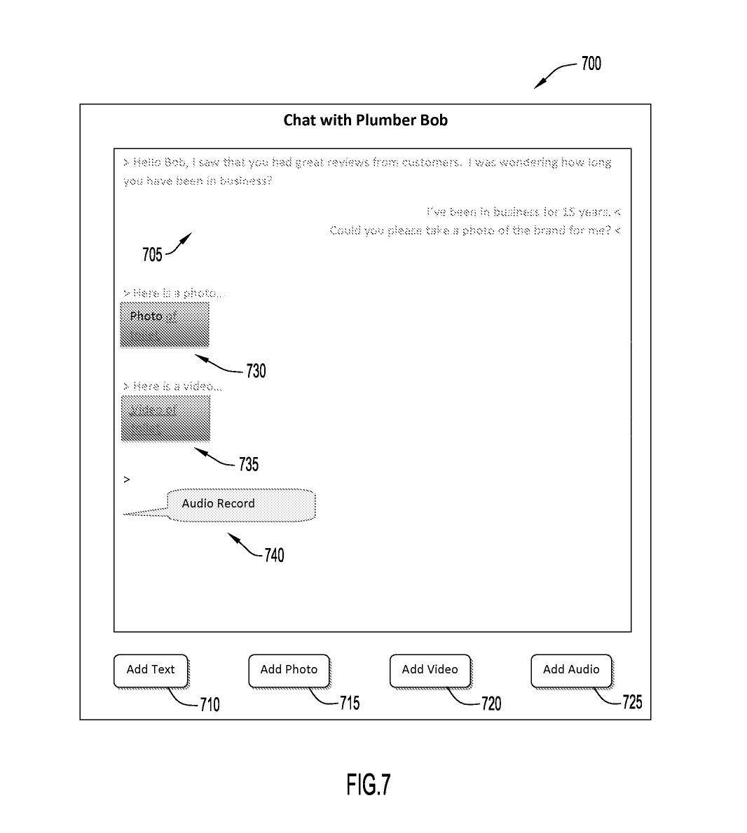

An example screen 700 for a chat session is depicted in FIG. 7. Initially, a service seeker selects the service provider to initiate a chat as described above (e.g., for FIG. 6). In this figure, the service seeker may perform the following:

enters comments into text area 705 via a text button 710 (and receives comments within this text area);

optionally takes photographs (e.g., opens a web camera on the computer) or browses for photographs (e.g., opens a popup window allowing selection of photographs from the computer) describing the service via a photograph button 715, where the photograph (or link) is presented on the chat screen in a photograph section 730;

optionally records a video file (e.g., opens a web camera on the computer) or browses for a video file (e.g., opens a popup window allowing selection of a video file from the computer) describing the service via a video button 720, where the video file (or link) is presented on the chat screen in a video section 735; and

optionally records an audio file (e.g., opens a computer's microphone) or browses for an audio file (e.g., opens a popup window allowing selection of an audio file from the computer) describing the service via audio button 725, where the audio file (or link) is presented on the chat screen in an audio section 740.

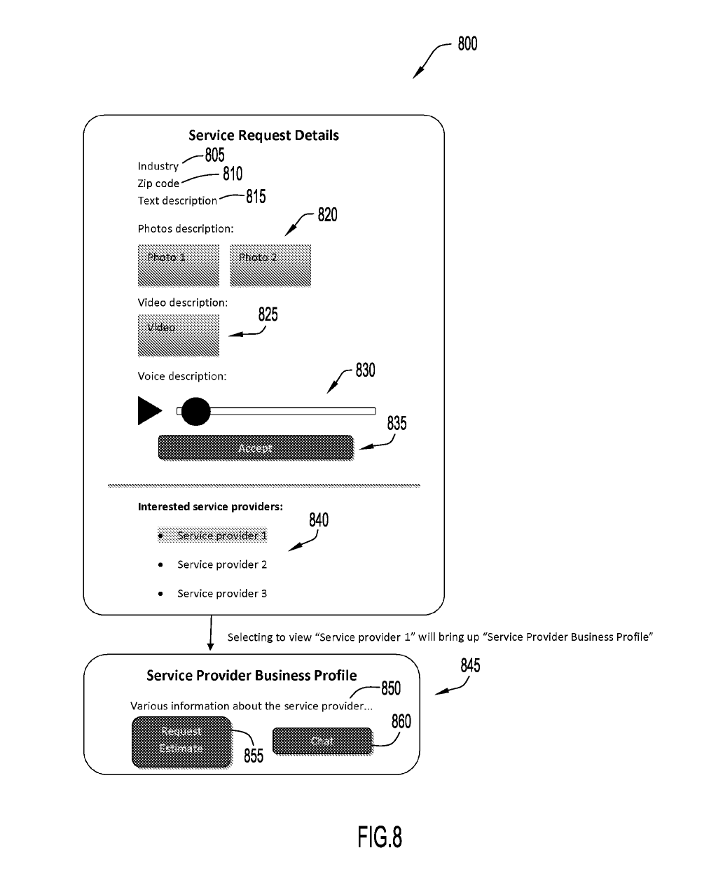

A second manner of initiating a chat includes a mobile application (FIG. 16) accessed from a mobile telephone. From a mobile application, there is a screen 800 that displays the details of a service request as illustrated, by way of example, in FIG. 8. Initially, screen 800 may be presented from a main option or other screen (e.g., FIG. 3). Within this screen, there is information about the service request, including industry 805, zip code 810, a text description 815, photographs 820, video 825, and a voice description 830. An accept button 835 enables the service seeker to accept an offer from a service provider. In addition, screen 800 includes a service provider section 840 that lists service providers who show interest in the service request. Clicking on a service provider shows a business profile screen 845 for the selected service provider including various information 850, an estimate button 855 and a chat button 860. The estimate button requests an estimate from the selected service provider, while the chat button initiates a real-time chat. After entering into a chat, a new screen appears, allowing service seekers to engage in a multimedia chat with the service provider as described below.

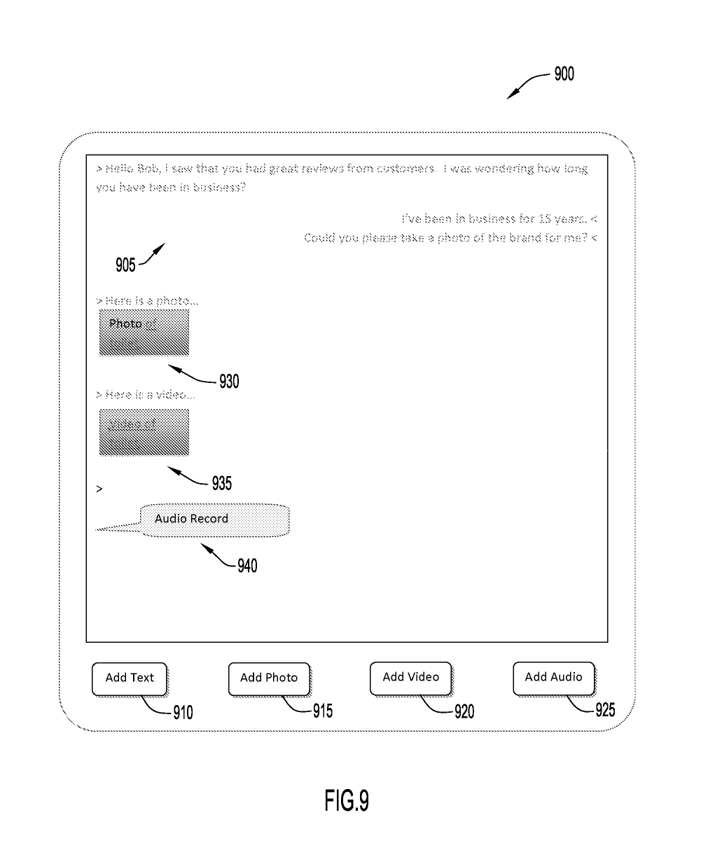

An example screen 900 for a chat session is depicted in FIG. 9. Initially, the service seeker selects the service provider to initiate a chat as described above (e.g., for FIG. 8). In this figure, the service seeker may perform the following:

enters comments into a text area 905 via a text button 910 (and receives comments within this text area);

optionally takes photographs (e.g., opens a camera on the mobile telephone) or browses for photographs (e.g., opens a new screen allowing selection of photographs from the mobile telephone's library) describing the service via a photograph button 915, where the photograph (or link) is presented on the chat screen in a photograph section 930;

optionally records a video file (e.g., opens a video camera on the mobile telephone) or browses for a video file (e.g., opens a new screen allowing selection of a video file from the mobile telephone's library) describing the service via a video button 920, where the video file (or link) is presented on the chat screen in a video section 935; and

optionally records an audio file (e.g., opens a voice recorder on the microphone) or browses for an audio file (e.g., opens a new screen allowing selection of an audio file from the mobile telephone's library) describing the service via an audio button 925, where the audio file (or link) is presented in the chat screen in an audio section 940.

A fourth service the system offers to service seekers is a way in which the service seekers can receive location-sensitive and behavior-sensitive advertisements, deals, and/or coupons. A service seeker uses a mobile application to periodically report the service seeker's current location to the system, and to make service requests, which allows the system to distribute the appropriate advertisements, deals, and/or coupons (e.g., created by the service providers and/or advertisers) to the service seeker.

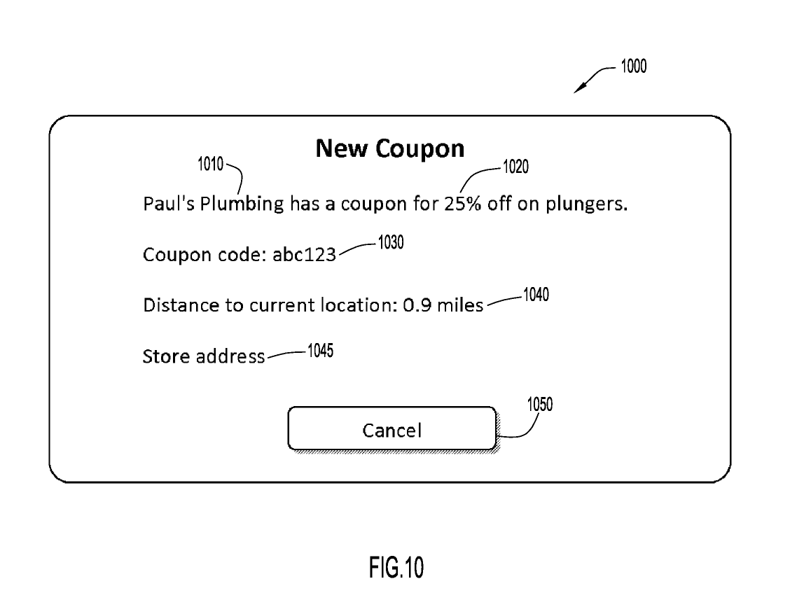

An example coupon 1000 received by a service seeker is depicted in FIG. 10. The coupon is received when service seekers meet criteria of advertisements, deals, and/or coupons created by a service provider and/or advertiser. In this example case, since the service seeker recently searched for plumbers on the system website and is currently in the zip code 20850 (e.g., reported by the service seeker's mobile application), the system sends a local hardware store's coupon that provides a discount on plumbing supplies to the service seeker (e.g., via a web browser or mobile application). The coupon includes the name of the service provider or advertiser 1010, a discount 1020, a coupon code 1030, a distance 1040 from the service provider or advertiser to the current location of the service seeker, and an address 1045 of the service provider or advertiser. A cancel button 1050 enables a service seeker to close the window or screen.

Present invention embodiments further provide a myriad of services for service providers. A first service the system offers for service providers includes a way in which the service providers can receive location-sensitive service requests (e.g., created by the service seekers) based on the tracking of the service providers' current locations. A service provider uses a mobile application (FIG. 16) accessed from a mobile telephone to periodically report that service provider's current location to the system, which allows the system to distribute the appropriate service requests to that service provider based on location as described below.

The first service can be accessed in plural manners. A first manner of accessing location-sensitive service requests includes a mobile application (FIG. 16) accessed from a mobile telephone. The service provider can choose to receive mobile notifications. This option allows the service provider to receive notifications regarding service requests via the mobile application. The notification contains job description information, but typically not the service seeker's contact information. By accepting this service request notification, the service provider indicates interest and is able to see the service seeker's contact information. At this point, the service provider can contact the service seeker directly, and/or choose to send an estimate back to or engage in a real-time chat with the service seeker.

An example notification 1100 for a mobile application is depicted in FIG. 11. A popup notification 1100 appears on the mobile telephone with an indication 1110 (e.g., indicating an industry job in a particular zip code) telling the service provider that there is a new service request. The notification includes a cancel button 1115 and a view button 1120. Tapping the cancel button closes the popup notification, while tapping the view button takes the service provider to a mobile application's service request screen 1130 showing the service request description, including an industry 1135, a zip code 1140, a text description 1145, zero or more photographs 1150, zero or more videos 1153, and an audio recording 1155.

At the bottom, there is an accept button 1160. Tapping the accept button takes the service provider to a new screen 1170 with the service seeker's contact information 1175. At the bottom of this screen, there is an estimate button 1180 and a chat button 1185. The service provider can either contact the service seeker at this point, tap the estimate button to submit a quote and comments, or engage in a real-time chat by tapping chat button 1185.

A second manner of accessing location-sensitive service requests includes a website of a server system (FIG. 16) accessed from a web browser of a client system. The service provider can choose to receive web notifications. This option allows the service provider to receive popup notifications regarding service requests via the website. The notification contains job description information, but typically not the service seeker's contact information. By accepting this service request, the service provider indicates interest, and is able to see the service seeker's contact information. At this point, the service provider can choose to contact the service seeker directly, and/or send an estimate back to or engage in a real-time chat with the service seeker. The web browser may employ substantially the same windows and functionality for accessing the location-sensitive service requests as those described above for the mobile application (e.g., FIG. 11).

A second service the system offers for service providers includes a way to browse for service requests. The service providers can browse a list of service requests in the form of a directory or a map near a desired location, and further drill down into a service request's job description information. By accepting this service request, the service provider indicates interest and is able to see the service seeker's contact information. At this point, the service provider can choose to contact the service seeker directly, and/or send an estimate back to, or engage in a real-time chat with, the service seeker.

The second service can be accessed in plural manners. A first manner is a website of a server system (FIG. 16) accessed from a web browser of a client system. From a web browser, the service providers can choose to browse a directory or a map of service requests. If a service provider chooses to browse a directory, the service provider can then view a list of service requests and can sort the list by the following criteria: time of service request; and distance from the service location to a search location (e.g., a static location or a current location). The service seeker and service provider can access this service via a location-aware device (e.g., a smart phone, etc.) which can keep track of their location in order to sort by current location. If the service provider chooses to browse a map, the service provider can view a map of all service requests.

A second manner includes a mobile application (FIG. 16) accessed from a mobile telephone. From a mobile telephone, the service providers can choose to either browse a directory or a map of service requests near a desired location. If a service provider chooses to browse a directory, the service provider can view a list of service requests and can sort the list by the following criteria: time of service request; and distance from a service location to a search location (e.g., a static location or a current location). The service seeker and service provider can access this service via a location-aware device (e.g., a smart phone, etc.) which can keep track of their location in order to sort by current location.

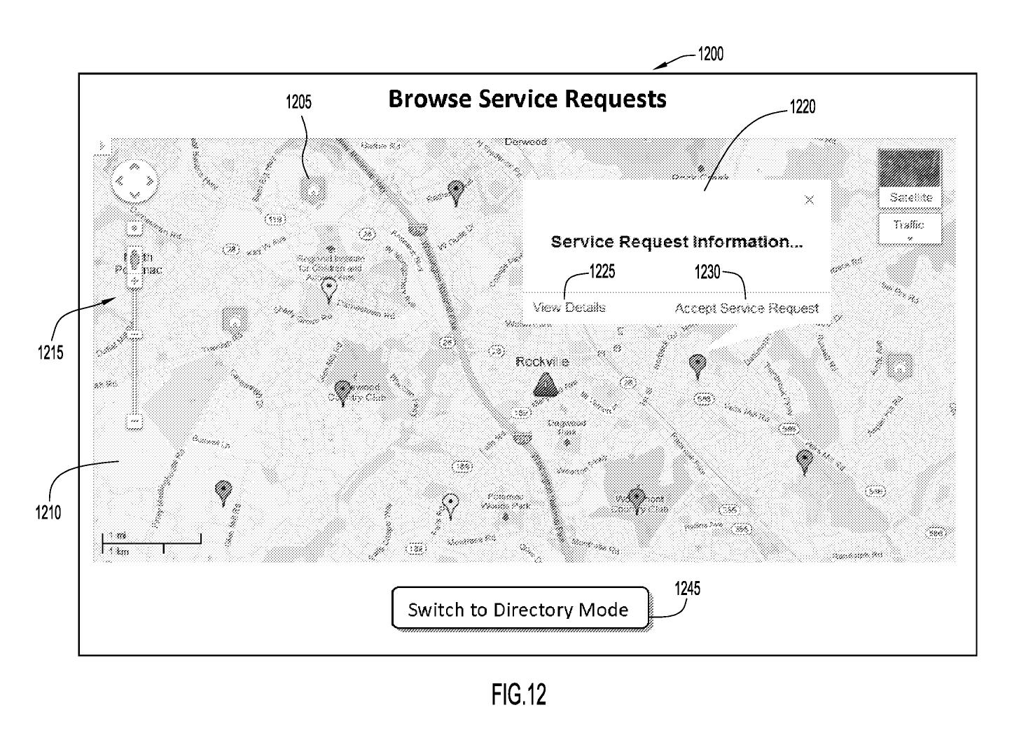

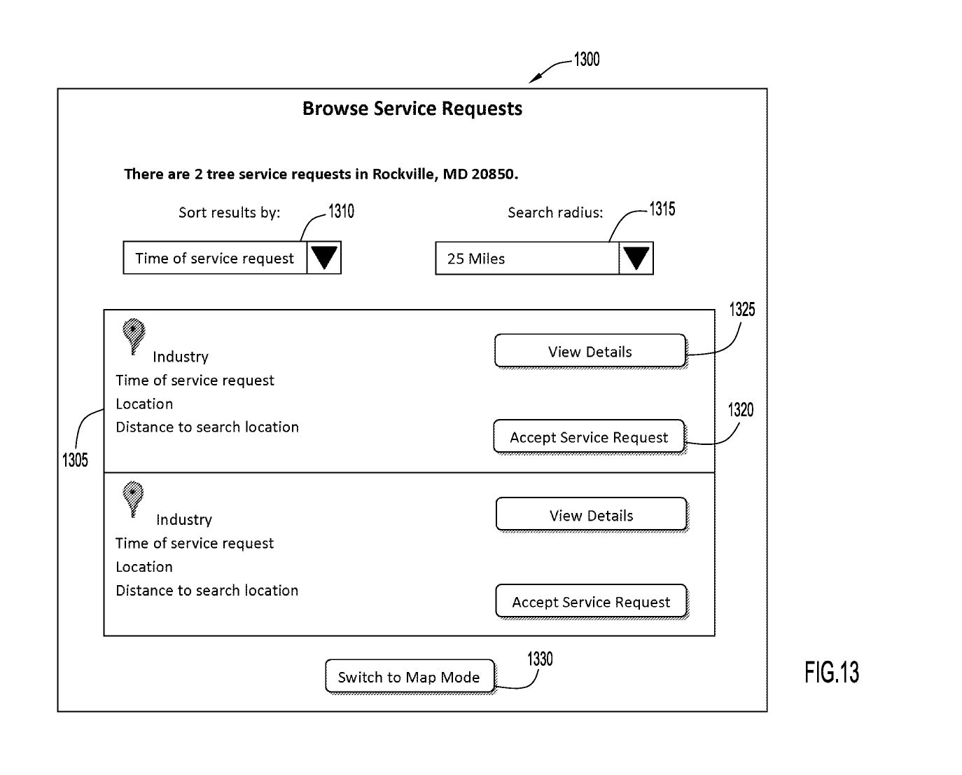

An example map 1200 of service seeker requests (e.g., from a web browser or mobile application) is depicted in FIG. 12. Initially, map 1200 may be presented from a main option or other screen (e.g., FIG. 13). Service providers can view a map of all service requests, and click on associated icons 1205 for detailed information about a corresponding service request. In particular, the service provider enters a search zip code (not shown in FIG. 12), and a map 1210 appears centered at the service zip code, having a default radius of a predetermined number of miles. The zoom level of the map can be adjusted from the top left by clicking on + or − buttons 1215.

Icons 1205 on the map represent service requests, where these icons are generally rectangular and include buildings. The generally circular icons represent the service providers' respective current locations. Icons 1205 representing the service requests are color coded according to the time at which the service request was issued (e.g., green indicates that the service request was made within a predetermined number of hours, yellow indicates that the service request was made in a range of a predetermined number of hours ago, and red indicates that the service request was made at least a predetermined number of hours ago). By clicking on an icon of a specific service request, a popup window appears showing that service request's job description information 1220, and enabling the service provider to view details via actuator or link 1225 and accept a service request via actuator or link 1230. If the service provider accepts the service request, the service seeker's contact information appears with the option to give an instant estimate and engage in a real-time chat as described above. In addition, there is a button 1245 to allow the service providers to switch to a directory mode (e.g., substantially similar to FIG. 13 described below).

An example directory of service requests is depicted in FIG. 13. Initially, directory 1300 may be presented from a main option or other screen (e.g., FIG. 12). A service provider can view a list of service requests 1305, and click on each for detailed information about that service request. The service provider enters the service zip code (not shown in FIG. 13), and a directory appears with a list of service requests 1305, having a default search radius of a number miles. At the top of the list, there is an actuator or drop-down list 1310 that allows service providers to sort by time of service request or distance. There is another actuator or drop-down list 1315 that allows service providers to change the search mileage radius. A subset of each service request's job description information is shown in list 1305 (e.g., industry, time of service request, location, distance to search location, a current location icon if this is the current location of the service seeker, etc.). Clicking on a view details button 1325 of a service request brings up a new page with the detailed job description information (e.g., industry, zip code, text description, photographs, audio recording, etc.).

In addition, a service provider may accept a service request via an accept service request button 1320. If the service provider accepts the service request, the service seeker's contact information appears with an option to give an estimate and engage in a real-time chat as described above (e.g., FIG. 11). There is a further button 1330 on this page that allows service providers to switch to map mode (e.g., substantially similar to FIG. 12 described above). For example, if the service providers choose to browse a map, they can view a map of all service requests as described above.

A third service the system offers is a way for service providers to create location-sensitive and behavioral-sensitive advertisements, deals, and/or coupons (e.g., FIG. 10). The service providers can take/upload photographs and/or record/upload video of advertisements, deals, and/or coupons, or fill out a form to create the advertisements, deals, and/or coupons. The service providers also specify the targeted audience and location for the advertisements, deals, and/or coupons. The system distributes the advertisements, deals, and/or coupons to the service seekers if and when they satisfy the criteria for the advertisements, deals, and/or coupons (e.g., specified targeted audience and location).

This service can be accessed in plural manners. A first manner is a website of a server system (FIG. 16) accessed from a web browser of a client system. The service providers can either take photographs (e.g., open a web camera on the computer) or browse for photographs (e.g., open a popup window allowing selection of photographs from the computer) of the advertisements, deals, and/or coupons. The service providers can either record a video of the advertisements, deals, and/or coupons (e.g., open a web camera on the computer) or browse for video of the advertisements, deals, and/or coupons (e.g., open a popup window allowing selection of video files from the computer). The service providers can also choose to fill out a form to create the advertisements, deals, and/or coupons by entering the necessary information. The service providers specify their targeted audience (e.g., service seekers looking for plumbing service, etc.) and location (e.g., service seekers who are currently in Montgomery County, Md.) by filling out a form.

A second manner of creating advertisements, deals and/or coupons is via a mobile application (FIG. 16) accessed from a mobile telephone. The service providers can take photographs (e.g., open a camera on the mobile telephone) or browse for photographs (e.g., open a new screen allowing selection of photographs from the mobile telephone's library) of the advertisements, deals, and/or coupons. The service providers can either record a video of the advertisements, deals, and/or coupons (e.g., open a camera on the mobile telephone) or browse for video of the advertisements, deals, and/or coupons (e.g., open a new screen allowing selection of video files from the mobile telephone). The service providers can also choose to fill out a form to create the advertisements, deals, and/or coupons by entering the necessary information. The service providers also specify a targeted audience (e.g., service seekers looking for plumbing service, etc.) and location (e.g., service seekers who are currently in Montgomery County, Md.) by filling out a form.

A fourth service the system offers is a way to track the service providers' current locations and have the system send them location-sensitive and behavior-sensitive advertisements, deals, and/or coupons (created by advertisers). The service provider uses a mobile application (FIG. 16) accessed from a mobile telephone that periodically reports their current location to the system, which allows the system to distribute the appropriate advertisements, deals, and/or coupons (created by the advertisers) to the service providers.

Present invention embodiments further provide services for the advertisers. A service the system offers is a way in which advertisers can create location-sensitive and behavioral-sensitive advertisements, deals, and/or coupons (e.g., FIG. 10). The advertisers can take/upload photographs or record/upload video of, or fill out a form to create, the advertisements, deals, and/or coupons. The advertisers also specify the targeted audience and location for the advertisements, deals, and/or coupons. The system distributes the advertisements, deals, and/or coupons to the service seekers and service providers if and when they satisfy the criteria for the advertisements, deals, and/or coupons (e.g., specified targeted audience and location).

This service can be accessed in plural manners. A first manner is a website of a server system (FIG. 16) accessed from a web browser of a client system. The advertisers can take photographs (e.g., open a web camera on the computer) or browse for photographs (e.g., open a popup window allowing selection of photographs from the computer) of the advertisements, deals, and/or coupons. The advertisers can record a video of the advertisements, deals, and/or coupons (e.g., open a web camera on the computer) or browse for video (e.g., open a popup window allowing selection of video files from the computer) of the advertisements, deals, and/or coupons. The advertisers can also choose to fill out a form to create the advertisements, deals, and/or coupons by entering the necessary information. The advertisers also specify their target audience(s) and location(s) by filling out a form.

A second manner of advertisers creating advertisements, deals, and/or coupons includes a mobile application (FIG. 16) accessed from a mobile telephone. The advertisers can either take photographs (e.g., open a camera on the mobile telephone) or browse for photographs (e.g., open a new screen allowing the advertiser to select photographs from the mobile telephone's library) of the advertisements, deals, and/or coupons. The advertisers can record a video of the advertisements, deals, and/or coupons (e.g., open a web camera on the mobile telephone) or browse for video of the advertisements, deals, and/or coupons (e.g., open a new screen allowing selection of video files from the mobile telephone). The advertisers can also choose to fill out a form to create the advertisements, deals, and/or coupons by entering the necessary information. The advertisers also specify the target audience(s) and location(s) by filling out a form.

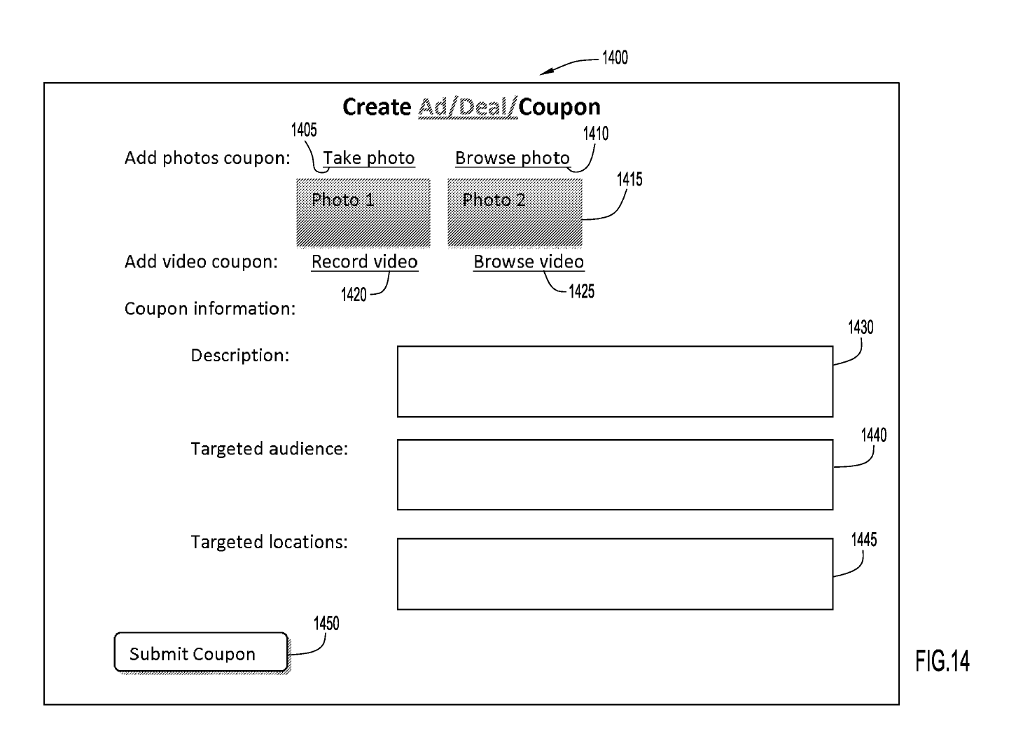

An example screen 1400 for creating a promotion (e.g., advertisement, deal, coupon, etc.) is illustrated in FIG. 14. Initially, screen 1400 may be presented (e.g., from a main option or other screen) to service providers and advertisers via the manners described above (e.g., web browser of client system, mobile application of a mobile telephone, etc.). Initially, the service provider and/or advertiser fills out the screen to provide information about the promotion (e.g., advertisement, deal, coupon, etc.) for distribution. The screen may be completed by a service provider and/or advertiser as follows:

optionally takes photographs via an actuator or link 1405 (e.g., opens a camera on the computer or mobile telephone) or browses for photographs via an actuator or link 1410 (e.g., opens a new screen allowing selection of photographs from the computer or mobile telephone library) describing the promotion;

optionally records a video file (e.g., opens a video camera on the computer or mobile telephone) via an actuator or link 1420 or browses for a video file via an actuator or link 1425 (e.g., opens a new screen allowing selection of a video file from the computer or mobile telephone's library) describing the promotion;

enters promotion information including a description in field 1430, a targeted audience in a field 1435, and targeted locations in a field 1445; and

submits the promotion for distribution via an actuator or link 1450.

The system of a present invention embodiment (FIG. 16) includes software executed on a server system, a cluster of server systems, and/or a cloud environment that can be accessed by users (e.g., service seekers, service providers, advertisers, etc.). The system functions include storing/retrieving data into/from a database, answering different requests of users, keeping track of service seekers' and service providers' current locations, distributing service requests to service providers, and distributing location-sensitive advertisements, deals, and/or coupons to service seekers and service providers.

The system communicates with the database, which contains, by way of example, service seeker account information, service seeker activity information, service provider account information, service provider profile information, service provider activity information, advertiser account information, and advertisement, deal, and coupon information.

The system also answers different requests from users. The requests include service requests from service seekers, estimates from service providers, real-time chat from service seekers and service providers, etc. The users can use different manners of accessing the system, including a website of a server system from a web browser of a client system and a mobile application from a mobile telephone or other mobile device. The web browser may include any suitable browser or network interface (e.g., INTERNET EXPLORER, FIREFOX, GOOGLE CHROME, SAFARI, OPERA, etc.). The mobile telephones or devices may include any suitable types of mobile devices (e.g., IPHONE, ANDROID, BLACKBERRY, WINDOWS, etc.).

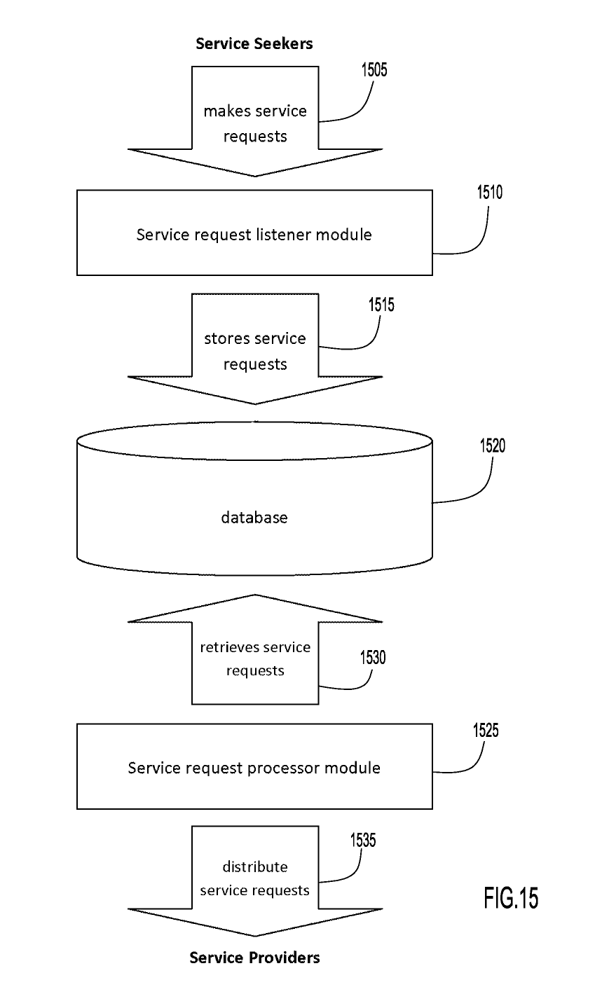

Service seekers and service providers report their current locations to the system. This is accomplished by service seekers and service providers utilizing location-aware devices (e.g., a smart phone or other mobile device, computer system, etc.) to keep track of their locations and update the system. The system distributes service requests to service providers as described below (FIG. 15).

The system further distributes location-sensitive and behavioral-sensitive advertisements, deals, and/or coupons to service seekers and service providers. The service providers and advertisers submit advertisements, deals, and/or coupons and specify criteria for their distribution (e.g., targeted location and type of users) as described above. The system sends the service seekers and service providers a notification (e.g., via a website, mobile device, SMS, e-mail, etc.), preferably instantly, about the advertisements, deals, and/or coupons when service seekers or service providers satisfy the targeted type of user (e.g., a service seeker looking for plumbing service, etc.) and are at a certain location (e.g., currently in zip code 20850). The information for the comparisons (e.g., criteria, user information, location information, etc.) may be obtained from the database.

A manner of handling service requests according to an embodiment of the present invention is illustrated in FIG. 15. Initially, service seekers make service requests via client systems or mobile devices at flow 1505. A service request listener module 1510 of a server system (FIG. 16) listens for the service requests, and stores the service requests in a database 1520 at flow 1515. A service request processing module 1525 of the server system (FIG. 16) periodically queries database 1520 for active service requests (e.g., service requests where the number of service provider responses are lower than the maximum requests allowed, and the service request is not older than a predetermined number of days) at flow 1530.

From these active service requests, the service request processor module finds all service providers corresponding to the requested services who have not received a notification for those service requests. From those service providers, the following criteria are considered to determine who receives a notification:

the service provider(s) whose current zip code is near the service request zip code has the highest priority and receives the notifications the earliest; and

the service provider(s) whose area of service covers the service request zip code has the next highest priority and receives the notifications after the service providers of the higher priority.

If the service provider receives a disproportionally large amount of service requests (based on empirical data), that service provider's notification could be delayed to allow other service providers to respond to the service request (unless there are not a sufficient amount of qualified service providers). Once the priorities are determined for the service providers, the service requests are distributed to the service providers in accordance with the priorities at flow 1535. The service providers may respond to the service requests, be placed in maps or directories, and interact with service seekers as described above.

An example computing environment of a system for handling service requests in the manners described above according to an embodiment of the present invention is illustrated in FIG. 16. The system includes one or more server systems 1600 with software (e.g., service request listener module 1510, service request processor module 1525, etc.) executed thereon, and one or more client devices or systems 1610 with software (e.g., mobile application 1625) executed thereon. The server system may include a cluster of servers or a cloud. The system exposes an API to clients 1610 to access its services. The client devices utilize Internet 1615 or other network to access server system 1600. The system holds all the business logic, algorithms and libraries, and has access to or includes various servers 1620 (e.g. e-mail server, SMS server, database server including or in communication with database 1520, IP address lookup server, and any other server or processing device) suitable to perform system functions.

The computing environment may include various mobile client devices that can access the server system (e.g., IPHONES, ANDROID, BLACKBERRY, WINDOWS, etc.) and include mobile application 1625 to perform the various functions. The client devices may further include computer systems with various web browsers (e.g., INTERNET EXPLORER, FIREFOX, GOOGLE CHROME, SAFARI, OPERA, etc.) that can access the server system. The server system may be accessed by the Internet or any other desired network. The environment may include any quantity of client devices in the faun of mobile devices and/or computer systems. Peripheral servers 1620, by way of example, include the e-mail server which sends/receive emails, the SMS server which can send/receive text messages, the database server which stores/retrieves data in database 1520, and an IP address lookup server which can determine the location of users.

Server systems 1600 may be implemented by any conventional or other computer systems preferably equipped with a display or monitor, a base (e.g., including at least one processor 1630, one or more memories 1650 and/or internal or external network interfaces or communications devices 1640 (e.g., modem, network cards, etc.)), optional input devices (e.g., a keyboard, mouse or other input device), and any commercially available and custom software (e.g., server/communications software, service request listener module, service request processor module, etc.).

Client devices 1610 may be implemented by any conventional or other processing device or computer system preferably equipped with a display or monitor, at least one processor 1630, one or more memories 1650 and/or internal or external network interfaces or communications devices 1640 (e.g., modem, network cards, transceiver, etc.)), optional input devices (e.g., a keyboard, mouse or other input device, touch screen, etc.), and any commercially available and custom software (e.g., browser/communications interface, mobile application, etc.).

Service request listener module 1510, service request processor module 1525, and mobile application 1625 may include one or more modules or units to perform the various functions of present invention embodiments described above. The various modules (e.g., service request listener module, service request processor module, mobile application, etc.) may be implemented by any combination of any quantity of software and/or hardware modules or units, and may reside within memory 1650 of server systems 1600 and client devices 1610 for execution by processor 1630.

It will be appreciated that the embodiments described above and illustrated in the drawings represent only a few of the many ways of implementing a system and method for handling service requests.

The environment of the present invention embodiments may include any quantity of client devices, server systems, and databases. The client devices and server systems employed by the present invention embodiments may be implemented by any quantity of any personal or other type of computer system (e.g., desktop, laptop, PDA, mobile device, etc.), and may include any commercially available operating system (e.g., Windows, OS/2, Unix, Linux, etc.) and any commercially available or custom software (e.g., browser software, communications software, server software, mobile application, service request listener module, service request processor module, etc.). These systems may include any types of monitors or display screens and input devices (e.g., keyboard, mouse, voice recognition, touch screen, etc.) to enter and/or view information.

It is to be understood that the software (e.g., mobile application, service request listener module, service request processor module, etc.) for the computer systems or processing devices of the present invention embodiments (e.g., server systems, client devices or systems, etc.) may be implemented in any desired computer language and could be developed by one of ordinary skill in the computer arts based on the functional descriptions contained in the specification and flow diagrams and/or flow charts illustrated in the drawings. Further, any references herein of software performing various functions generally refer to computer systems or processors performing those functions under software control.

The computer systems and/or processing devices of the present invention embodiments may alternatively be implemented by any type of hardware and/or other processing circuitry. The various functions of the computer systems and client devices may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the client devices and server systems, and/or any intermediary processing devices. The software and/or algorithms described above and illustrated in the flow diagrams and/or flow charts may be modified in any manner that accomplishes the functions described herein. In addition, the functions in the flow diagrams and/or flow charts or description may be performed in any order that accomplishes a desired operation.

The software of the present invention embodiments may be available on a program product apparatus or device including a computer readable or computer usable storage medium (e.g., magnetic or optical mediums, magneto-optic mediums, floppy diskettes, CD-ROM, DVD, memory devices, etc.) for use on stand-alone systems or systems connected by a network or other communications medium. Alternatively, the software of present invention embodiments may be downloaded (e.g., in the form of carrier waves, packets, etc.) to systems via a network or other communications medium.

The communication network may be implemented by any quantity of any type of communications network (e.g., LAN, WAN, Internet, Intranet, VPN, etc.). The computer systems of the present invention embodiments (e.g., client devices, server systems, etc.) may include any conventional or other communications devices to communicate over the network via any conventional or other protocols. The computer systems (e.g., client devices, server system, etc.) may utilize any type of connection (e.g., wired, wireless, etc.) for access to the network.

The service requests and promotions may be distributed in any fashion based on any suitable criteria (e.g., distance, time of request, targeted audience, locations, etc.). For example, a specific company or service provider may have service requests from their customers go directly to that company or service provider (e.g., rather than to other companies or service providers within a specific area).

The present invention embodiments may employ any number of any type of user interface (e.g., Graphical User Interface (GUI), command-line, prompt, etc.) for obtaining or providing information (e.g., service requests, promotions, user information, maps, directories, etc.), where the interface (e.g., screens, forms, windows, boxes, etc.) may include any information (e.g., any quantity of multimedia or other objects (e.g., photograph or image, video, audio, text, etc.), fields, etc.) arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, touch screen, etc.). The various interfaces (e.g., screens, forms, windows, boxes, etc.) may include any suitable actuators (e.g., links, tabs, etc.) to navigate between the interfaces in any fashion. The maps and directories may include all service providers or service requests, or any portions thereof (e.g., service providers associated with a service request, service providers in a certain location, service requests associated with a service provider, service requests in a certain location, etc.).

The present invention embodiments are not limited to the specific tasks or algorithms described above, but may be utilized for connecting various people and/or entities (e.g., vehicle repair or assistance for inoperative vehicles, roadside assistance, etc.). For example, a service request may include any type of request for any items and/or services. By way of example, present invention embodiments may be utilized by insurance providers to have their customers describe and record information following an accident or other event and submit the incident for processing in substantially the same manner described above. This may also be applied for emergency/medical situations to enable persons at a scene of an event to inform appropriate agencies (e.g., police, fire, ambulance, etc.) and/or professionals (e.g., doctors, etc.) of incidents.

Further, present invention embodiments may be utilized for the hospitality industry (e.g., hotels, restaurants, attractions, grocery stores, etc.) in substantially the same manner described above. For example, rather than having to call a hotel front desk (e.g., for room service, another towel, pillow or toothbrush, etc.) guests may simply utilize present invention embodiments to make the request. Alternatively, present invention embodiments may be utilized to order (or pre-order) food (e.g., dine-in or carry out/delivery, groceries, etc.) at food establishments, or place requests for tickets to various attractions. Moreover, a company may utilize present invention embodiments to respond to customer orders/installation/repair requests. This is advantageous compared to customers having to utilize a computer for a “live chat” when available. Customers could communicate with the company at any time, from anywhere.

The various screens (e.g., service requests, estimates, chats, promotions, etc.) may enable uploading of any type of object (e.g., images, audio, video, documents (e.g., WORD, POWER POINT, PDF, spreadsheets, word processing files, presentation/slide files, text files, image files, etc.)), multimedia objects, etc.) for transference between service seeker and service provider. Moreover, any location information (e.g., GPS or other coordinates, etc.) providing locations for any persons or entities (e.g., service seeker and/or service provider locations, store/business locations, etc.) may be transferred between service seekers and/or service providers. Service requests and/or service providers may be searched (e.g., maps, directories, etc.) based on any information (e.g., zip code, city, town, state, country, GPS or other coordinates, etc.).

It is to be understood that the terms “top”, “bottom”, “front”, “rear”, “side”, “height”, “length”, “width”, “upper”, “lower”, “vertical”, “horizontal”, “right”, “left” and the like are used herein merely to describe points of reference and do not limit the present invention to any particular orientation or configuration. It will be further understood that the terms “comprises”, “comprising”, “includes”, “including”, “has”, “have”, “having”, “with” and the like, when used in this specification (including the claims), specify the presence of features, but do not preclude the presence or addition of one or more other features.

From the foregoing description, it will be appreciated that the invention makes available a novel system and method for managing requests for service, wherein one or more service providers capable of handling a service request are identified and an originator of the service request is notified of the identified service providers.

Having described preferred embodiments of a new and improved system and method for managing requests for service, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A computer-implemented method of handling service requests comprising:
receiving one or more service requests from service seekers requesting performance of a service;
identifying service providers that provide the requested services based on at least the current location of the service providers relative to the location for performing the requested service; and
facilitating communication between the service seekers and the identified service providers.

2. The method of claim 1, wherein a service request includes at least one of an image, a video, a document, and an audio recording providing information pertaining to a requested service.

3. The method of claim 1, wherein the communication includes an estimate of costs for an identified service provider to perform a requested service.

4. The method of claim 1, further including:
presenting a map indicating at least one of locations of identified service providers and the locations for performance of services of the service requests.

5. The method of claim 1, further including:
presenting a directory including information for one of identified service providers and service requests.

6. The method of claim 1, wherein the communication includes a real-time chat session.

7. The method of claim 6, wherein the real-time chat session enables transference of at least one of an image, a video, a document, and an audio recording providing information pertaining to a service request.

8. The method of claim 1, further including:
distributing a promotion for at least one of items and services to at least one of service providers and service seekers based on one or more specified criteria.

9. The method of claim 1, wherein receiving one or more service requests includes:
receiving at least one service request and a location from a first mobile device for at least one service seeker; and
facilitating the communication includes:
facilitating the communication and receiving a location of at least one service provider via a second mobile device for the at least one service provider.

10. A system for handling service requests comprising:
a computer system including at least one processor configured to:
receive one or more service requests from service seekers requesting performance of a service;
identify service providers that provide the requested services based on at least the current location of the service providers relative to the location for performing the requested service; and
facilitate communication between the service seekers and the identified service providers.

11. The system of claim 10, wherein a service request includes at least one of an image, a video, a document, and an audio recording providing information pertaining to a requested service.

12. The system of claim 10, wherein the communication includes an estimate of costs for an identified service provider to perform a requested service.

13. The system of claim 10, wherein the at least one processor is further configured to:
present a map indicating at least one of locations of identified service providers and the locations for performance of services of the service requests.

14. The system of claim 10, wherein the at least one processor is further configured to:
present a directory including information for one of identified service providers and service requests.

15. The system of claim 10, wherein the communication includes a real-time chat session.

16. The system of claim 15, wherein the real-time chat session enables transference of at least one of an image, a video, a document, and an audio recording providing information pertaining to a service request.

17. The system of claim 10, wherein the at least one processor is further configured to:
distribute a promotion for at least one of items and services to at least one of service providers and service seekers based on one or more specified criteria.

18. The system of claim 10, further including a first mobile device for at least one service seeker to provide the service requests and location of the at least one server seeker, and a second mobile device for at least one service provider to facilitate the communication and provide a location of the at least one service provider.

19. A computer program product for handling service requests comprising:
a computer readable storage medium having computer readable program code embodied therewith, the computer readable program code comprising computer readable program code configured to:
receive one or more service requests from service seekers requesting performance of a service;
identify service providers that provide the requested services based on at least the current location of the service providers relative to the location for performing the requested service; and
facilitate communication between the service seekers and the identified service providers.

20. The computer program product of claim 19, wherein a service request includes at least one of an image, a video, a document, and an audio recording providing information pertaining to a requested service.

21. The computer program product of claim 19, wherein the communication includes an estimate of costs for an identified service provider to perform a requested service.

22. The computer program product of claim 19, wherein the computer readable program code is further configured to:
present a map indicating at least one of locations of identified service providers and the locations for performance of services of the service requests.

23. The computer program product of claim 19, wherein the computer readable program code is further configured to:
present a directory including information for one of identified service providers and service requests.

24. The computer program product of claim 19, wherein the communication includes a real-time chat session.

25. The computer program product of claim 24, wherein the real-time chat session enables transference of at least one of an image, a video, a document, and an audio recording providing information pertaining to a service request.

26. The computer program product of claim 19, wherein the computer readable program code is further configured to:
distribute a promotion for at least one of items and services to at least one of service providers and service seekers based on one or more specified criteria.
